(19) United States
(12) Patent Application Publication
(10) Pub. No.: US 2013/0125693 A1
(43) Pub. Date: May 23, 2013

(54) FORK FOR EFFECTING THE TRANSLATIONAL MOVEMENT OF THE SLIDING SLEEVE IN A GEARBOX

(71) Applicants: Sebastien Maitre, Monistrol sur Loire (FR); Hugues Blanc, Lezigneux (FR)

(72) Inventors: Sebastien Maitre, Monistrol sur Loire (FR); Hugues Blanc, Lezigneux (FR)

(73) Assignee: DURA AUTOMOTIVE SYSTEMS SAS, Bievres (FR)

(21) Appl. No.: 13/701,263

(22) PCT Filed: May 31, 2011
(86) PCT No.: PCT/FR2011/051246

§ 371 Date: Feb. 5, 2013

(30) Foreign Application Priority Data
Jun. 2, 2010 (FR) 1054285

(51) Int. Cl. F16H 63/32

(52) U.S. Cl. CPC F16H 63/32
USPC 74/473.37

(57) ABSTRACT

The fork comprises inserts, overmoulded in a body made of a thermoplastic resin. The inserts have a modulus of elasticity at least twice as high as that of the thermoplastic resin and are shaped to form an arc-of-a-circle profile substantially matching the cross section delimited by the two prongs of the fork and, possibly, a ring for housing a drive shaft, The resin is charged, in particular with glass fibres, capable of linking the functions performed by said inserts.

This invention relates to the technical sector of gearboxes for motor vehicles.

More particularly, the invention concerns one of the means of the drive chain enabling transmission of the movements of a control lever or other activating device of a gearbox, notably for shifting gears.

For example, a selector cooperates with a recess that has a crosspiece fixed in one axis to move a fork for effecting the movement of a sliding sleeve for shifting gears. The gear-shift movement effected by the lever is transmitted to the fork coupled to a control bar connected to said gear lever or suchlike The fork moves the sliding sleeve thus engaging the desired gear. These arrangements are not described in detail because they are perfectly well known to a person skilled in the art and are likely to form the object of different variants.

The invention lies with the fork for effecting the movement in order to ensure the different gear changes.

According to the state of the art, the fork is made directly by casting, forming a one-piece assembly of considerable mass. Now, in the motor vehicle field, there is a constant desire to reduce weights. Costs are also important, given that investment casting must be used which, nevertheless, does not do away with the need for certain fabrication re-works.

The aim of the invention is to overcome these drawbacks in a simple, certain, effective and rational manner.

The problem that the invention proposes to solve is no longer to create this type of device by investment casting but by using, for part of it, an injected plastics material, bearing in mind that these parts work in aggressive environments, being subjected to high temperatures and vibrations.

In order to solve this problem, a fork has been designed and perfected for effecting the translational movement of a sliding sleeve in a gearbox, which comprises inserts, overmoulded in a body made of a thermoplastic resin, whose modulus of elasticity is at least twice as high as that of the thermoplastic resin and shaped to form a profile that matches the geometry and, possibly, a ring for housing a drive shaft, the said material being capable of linking the functions performed by said inserts.

On considering the function that this type of fork normally performs in the movement-transmission drive chain, the arc-of-a-circle profile is a flat bar substantially matching the cross section delimited by the two prongs of the fork.

According to another characteristic, the ring for housing the drive shaft is inserted, after overmoulding the body, into an orifice communicating with a through-hole to engage a means of locking in a translational and rotational manner the said ring and the said shaft. The locking means may be a pin.

The invention is described below in detail with the aid of the accompanying drawings, in which:

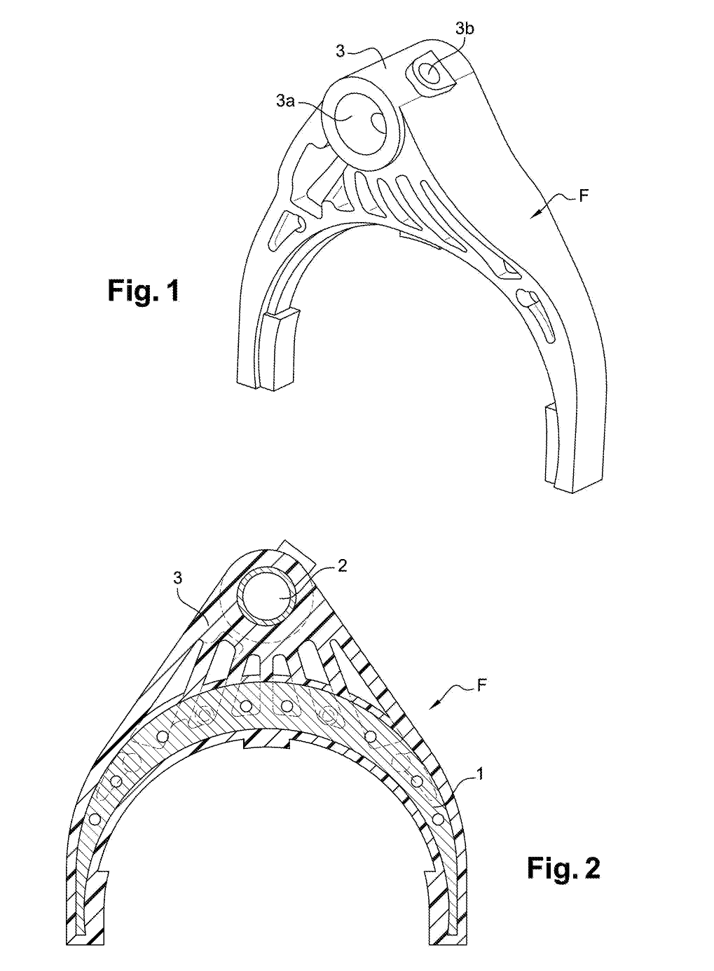

FIG. 1 is a perspective view of part of a movement-transmission drive chain for shifting gears, showing the application of the fork;

FIG. 2 is a perspective view of an embodiment of the fork;

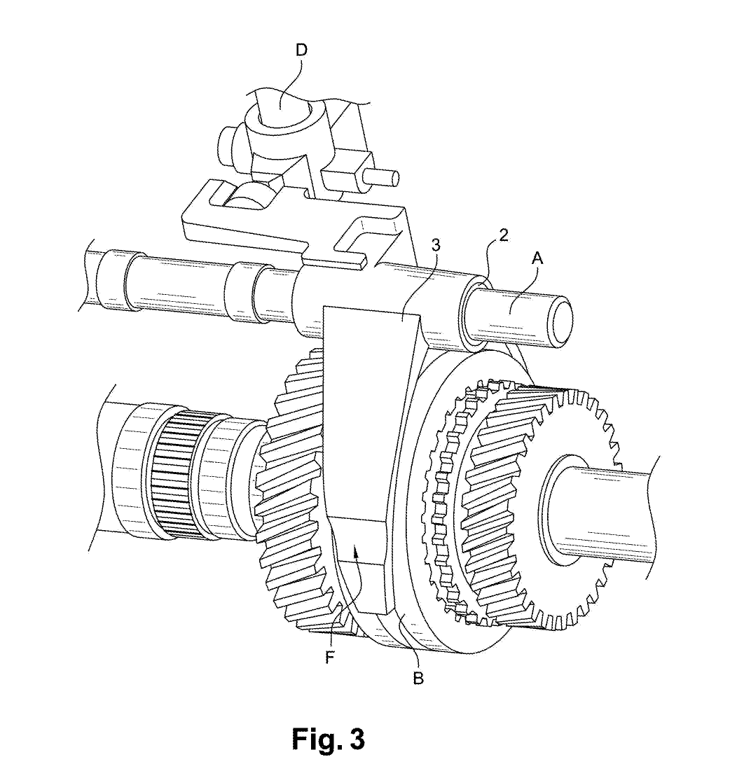

FIG. 3 is a longitudinal cross-section view of the fork.

In a perfectly known way, the movement for shifting a gear, for example by means of a control lever or suchlike, is transmitted to the fork (F) which moves a sliding sleeve (B), in order to engage the desired gear. The fork (F) is subject, for example, to a selector (D).

According to the invention, the fork (F) comprises inserts (1) and (2) overmoulded in a body (3) made of a thermoplastic material which is capable of linking the functions performed by the said inserts (1) and (2). The insert (1) constitutes a profile that matches the geometry. For example, this profile is obtained from a flat bar substantially matching the transverse section delimited by the two prongs of the fork so as to engage in the groove of the sliding sleeve, and has an arc-of-a-circle profile.

The insert (2) constitutes a ring for housing a drive shaft (A). This ring (2) is inserted, after overmoulding the body (3), into an orifice (3a), communicating with a through-hole (3b) to engage a means of locking the said shaft (A) in a translational and rotational manner. This locking means is, for example, a pin.

The inserts (1) and (2) are of metal, although this does not rule out other materials. The modulus of elasticity of the inserts is at least twice as high as that of the thermoplastic material.

Advantageously, the plastics material used for injecting the body (3), in order to withstand in particular the strong vibrations and high temperatures, is a thermoplastic material charged, in particular, with glass fibres, which can be selected from PPA-GF50, PPA-6.6 and PPA-4.6 resins.

The advantages clearly emerge from the description. In particular, we would stress and restate:
the weight saving achieved (around 50%);
the reduction in fabrication re-works;
the reduction in costs.

1- Fork for effecting translational movement of a sliding sleeve in a gearbox, comprising at least one insert, overmoulded in a body made of a thermoplastic resin, the at least one insert having a modulus of elasticity at least twice as high as a modulus of elasticity of the thermoplastic resin and shaped to form an arc-of-a-circle profile substantially matching the cross section delimited by prongs of the fork the resin being charged with glass fibres.

2- Fork according to claim 1, wherein the profile comprises a flat bar.

3- Fork according to claim 1, wherein the at least one insert comprises a ring for housing the drive shaft inserted, after overmoulding the body, into an orifice communicating with a through-hole to engage a means of locking the shaft in a translational and rotational manner.

4- Fork according to claim 3, wherein the locking means comprises a pin.
